(19) United States
(12) Patent Application Publication
(10) Pub. No.: US 2014/0017380 A1
(43) Pub. Date: Jan. 16, 2014

(54) Modified Bread Products and Methods of Making Same

(71) Applicant: Kate Bagorogoza, Cincinnati, OH (US)

(72) Inventor: Kate Bagorogoza, Cincinnati, OH (US)

(73) Assignee: ADVANCEPIERRE FOODS, INC., Cincinnati, OH (US)

(21) Appl. No.: 13/939,851

(22) Filed: Jul. 11, 2013

Related U.S. Application Data
(60) Provisional application No. 61/671,514, filed on Jul. 13, 2012.

(51) Int. Cl. A21D 2/22

(52) U.S. Cl. CPC A21D 2/22
USPC 426/549; 426/622

(57) ABSTRACT

A flour composition substantially free of ferric ions and a bread product made therefrom that is substantially free of ferric ions is disclosed. Methods of making the flour composition which is substantially free of ferric ions and of making bread products that are also free of ferric ions are disclosed. Additionally, food products that include said flour composition or bread product are disclosed.

### RELATED APPLICATIONS

This application claims the benefit of U.S. Provisional Application No. 61/671,514, filed Jul. 13, 2012, the entire content of which is incorporated by reference herein.

### TECHNICAL FIELD

Disclosed herein are bread products made from a flour that contains a reduced amount of ferric ions, which enhances or extends the shelf life of the bread product in when in contact with an egg product. In particular, the bread products do not experience discoloration when in contact with an egg product for an extended period of time.

### BACKGROUND

As seen in FIG. 1 some biscuits (bread products) discolor when in contact with egg for an extended period of time, in particular those made with whole wheat flour. While the sandwiches in FIG. 1 refrigerated for eight days, at acceptable refrigeration temperatures, are within industry standards for school sandwiches (bread products may be stored for up to 14 days at acceptable refrigeration temperatures), the discoloration of the whole wheat flour and the un-enriched white flour bread products would make a consumer unlikely to want to consume such a sandwich. Such discoloration is undesirable. While the eggs used in the tests for FIG. 1 are from chickens, the eggs (disclosed and claimed herein) may be from any egg laying animal.

The eggs used in FIG. 1 were “scrambled.” Scrambled generally means any one or more portions of an egg stirred up together along or in the presence of milk, water, or another liquid. In FIG. 1 the scrambled eggs included both the yolk and the white of the egg. It is also possible to scramble just the yolk or just the white of the egg if desired.

A cooked egg (also referred to as an egg product herein) emits, or is capable of emitting, a sulfur product, generally hydrogen sulfide or a derivative or complex thereof. The sulfur product may be an alkyl sulfide, such as methyl sulfide, ethyl sulfide, or another lower alkyl sulfide or disulfide or dialkyl sulfide. Generally the sulfur product is emitted as a result of natural decomposition of the substance, e.g., proteins and fats, in an egg yolk. The sulfur product may be emitted as a result of natural decomposition of sulfur-containing amino acids, e.g., methionine, cysteine, homocysteine, and/or taurine.

As noted in FIG. 1, the whole wheat flour and the un-enriched white flour include iron mostly as ferric ions. Flour is often enriched with B vitamins and minerals, especially iron. Iron enrichment may be in the form of inert elemental iron (as identified for the enriched white flour in FIG. 1) or ferrous sulfate, but depending on the milling extraction rate, environmental and genotypical variation, amounts of ferric and ferrous ions may vary in the all-purpose flour. The untreated whole wheat flour in FIG. 1 includes ferric ions as does the un-enriched white flour.

The inventors have determined that one or more of the sulfur products emitted by the egg reacts with the ferric ions present in the flour to form an iron (III) compound, which is believed to be iron sulfide. Iron sulfide has a gray-green color, resulting in the discoloration seen in FIG. 1 after 8 days of refrigeration.

### SUMMARY

In one aspect, flour compositions are disclosed that include a flour having a ferric ion content, as either free ions or bound ions, of at least 1 mg/100 mg of flour, and an amount of a comestibly acceptable reagent to reduce the ferric ions to ferrous ions. The comestibly acceptable reagent is present in an amount to decrease the ferric ion content to 0.5 mg/100 mg or less. In one embodiment, the comestibly acceptable reagent is in an amount to decrease the ferric ion content to 0.1 mg/100 mg or less.

In another aspect, the flour compositions disclosed herein may be made into a dough or batter by mixing the flour and comestibly acceptable reagent with one or more ingredients typically used to form a dough or batter. One of the one or more ingredients is a liquid. After mixing the flour composition and the other ingredients together the ferric ions are chemically reduced to ferrous ions and the resulting dough or batter has a ratio of ferrous to ferric ions is from 10⁴:1 to 10⁶:1, a pH between about 6.0 and about 6.7, and has the comestibly acceptable reagent present as about 0.05% to about 0.29% of the dough or batter.

In one embodiment, the comestibly acceptable reagent includes one or more of ascorbic acid, a salt made from ascorbic acid, an ascorbic acid derivative, citric acid, a salt made from citric acid, and a citric acid derivative.

In another aspect, the dough or batter may be baked or cooked into a bread product. This bread product may be packaged with an egg product. The bread product, because of having the ferric ions chemically reduced to ferrous ions, is unreactive with a sulfur product emitted from the egg product for a first period of at least fourteen days when refrigerated at an acceptable refrigeration temperature during said first period or for a second period of about 60 days to about 300 days when stored frozen during said second period, as evidenced by a lack of discoloration of the bread product.

In another aspect, a flour composition that includes a whole wheat flour or an all-purpose flour, where the flour composition is substantially free of ferric ions is disclosed. The amount of ferric ions present to be substantially free thereof is an amount less than 0.0005% weight/weight of the flour composition. In one embodiment, the flour composition has a ratio of ferrous to ferric ions is from 10⁴:1 to 10⁶:1 and a pH between about 6.0 and about 6.7. This flour composition may be a cooked or baked bread product. The bread product when in contact with or packaged with an egg product is unreactive with a sulfur product emitted from the egg product for a period of at least fourteen days when refrigerated at an acceptable refrigeration temperature during said period or for a period of about 60 days to about 300 days when stored frozen during said period, as evidenced by a lack of discoloration of the bread product.

In another aspect, methods for preparing a flour composition are disclosed. the methods include providing a flour having a ferric ion content, as either free ions or bound ions, of at least 1 mg/100 mg of flour and treating the flour with a comestibly acceptable reagent to reduce at least a portion of the ferric ions to ferrous ions. The method may also include adding ingredients to form the flour into a dough or batter; and baking or cooking the dough or batter into a bread product. Further, the method may include packaging the bread product with an egg product.

### BRIEF DESCRIPTION OF THE DRAWINGS

The patent or application file contains at least one photograph executed in color. Copies of this patent or patent application publication with color photograph(s) will be provided by the Office upon request and payment of the necessary fee.

FIG. 1 is a chart, including color photographs, of three different egg-biscuit sandwiches laid open after 24 hours and then again after refrigeration for 8 days.

FIGS. 2-4 are product sheets describing the physical and chemical composition of an egg product that may be combined with the bread product.

FIG. 5 is a product sheet describing the physical and chemical properties of an all-purpose flour.

### DETAILED DESCRIPTION

The following detailed description will illustrate the general principles of the invention, examples of which are additionally illustrated in the accompanying drawings.

The inventors have developed a flour, in one embodiment a whole wheat flour and in another embodiment an all-purpose flour, with a reduced amount of ferric ions and bread products made therefrom. While whole wheat flour and all-purpose flour have been mentioned, the flour is not limited thereto and instead may be derived from any other source such as barley, buckwheat, oat, rye, soy, or any other flour that has ferric ions naturally therein or is enriched with ferric ions. The benefit of the reduced amount of ferric ions in the flour and thus in the bread products is an enhanced or extended shelf life when in contact with an egg product. In particular, the bread products do not experience discoloration when in contact with an egg product for an extended period of time (typically time spent at acceptable refrigeration temperatures). In one embodiment, the bread products may be substantially free of ferric ions. In another embodiment, the bread products may include or be substantially increased with ferrous ions due to conversion of the ferric ions into ferrous ions.

As used herein, as is understood by a person of ordinary skill in the art, a ferric ion is represented as Fe (III) or Fe⁺³. In flour such ions are typically present as free ions or as bound ions. “Bound ions,” as used herein, means the ferric ions are part of an ionic compound, a complex, and adduct, or other chemical structure.

As used herein, as is understood by a person of ordinary skill in the art, a ferrous ion is represented as Fe (II), or Fe⁺². In flour such ions are typically present as free ions or as bound ions. “Bound ions,” as used herein, means the ferric ions are part of an ionic compound, a complex, and adduct, or other chemical structure.

As used herein, “substantially free” means 0.0005% or less, or even 0.0001% or less.

As used herein, the term “whole wheat” flour refers to flour in which the entire wheat grain, including the bran, germ and endosperm are finely ground and included in the flour product.

As is known in the industry, the term “all-purpose wheat flour” refers to flour in which the entire wheat grain, including the bran, germ and endosperm are ground and most of the bran and germ portions removed during milling. All-purpose wheat flour sold in the United States may be enriched with B vitamins and minerals, especially iron, previously lost during processing. Iron enrichment may be in the form of addition of inert elemental iron or ferrous sulfate. Amounts of ferric and ferrous iron may vary in the all-purpose flour depending on the milling extraction rate, environmental and genotypic variation.

A “bread product” as used herein means any bread-like product made of flour and other ingredients. The bread product may be, but is not limited to, biscuits, bread (loaf or flatbread), buns, pitas, wraps, pancakes, waffles, or other flour-based products that may be in contact with an egg product.

In one embodiment, the flour is substantially free of ferric ions after addition of a comestibly acceptable reagent capable of reducing ferric ions to ferrous ions. “Comestibly acceptable,” as used herein, means having no adverse and/or noticeable taste, texture or digestible qualities to a statistically significant number of human tasters in the end bread product. The comestibly acceptable reagent may be ascorbic acid or a salt or derivative thereof, e.g., ascorbyl palmitate or sodium ascorbate, citric acid or a salt or derivative thereof, and the like, and combinations thereof. The amount of comestibly acceptable reagent added to the flour should be sufficient to reduce the ferric ions present in the flour leaving the flour substantially free of ferric ions and be an amount that is comestible and ensures efficient leavening, if leavening is desired.

The flour may also include ferrous ions. The ferrous ions may be free ions or bound ions and may naturally exist in the source of the flour, e.g., the bran and germ of wheat. Additionally, ferrous ions may be present in the flour composition as a result of the comestibly acceptable reagent reducing the ferric ions to ferrous ions. For example, if the comestibly acceptable reagent is ascorbic acid, the following reaction can occur:

Fe(III)+Ascorbic acid→Fe(II) ascorbate.

In the form of Fe(II) ascorbate, the iron is not available to rect with a sulfur product emitted from an egg product, thereby preventing discoloration of the bread product containing the flour composition.

The flour can include or can have added to it fat, including saturated fats, polyunsaturated fats, monounsaturated fats; carbohydrates; fiber, including water-soluble and water-insoluble fiber; ash; the elements chlorine, calcium, iron, magnesium, phosphorous, potassium, sodium, zinc, copper, or manganese; or a salt or a derivative of one or more of the preceding elements; vitamins, including Vitamin C, thiamines, riboflavins, niacins, pantothenic acids, Vitamin B-6, Vitamin B-12, Vitamin A, Vitamin E; or salts or derivatives thereof; cholesterols; sugars; and other ingredients known to the those of skill in the art. The flour can take a variety of forms, including wheat biscuit flour (including about 9 to 10% weight/weight protein), whole wheat bread flour (including about 12 to 14% weight/weight in protein), or whole wheat cake flour (including about 7 to 9% weight/weight protein). The predominant protein in the flour is formed from by glutenins (which may also be known as gliadins), also known as gluten proteins.

The various flours described above may then be combined with other ingredients to make bread products. The bread products will benefit from the reduced ferric ion content of the flour and likewise have a reduced ferric ion content. In one embodiment, the bread products are substantially free of ferric ions. In another embodiment, the bread product is substantially free of ferric ions and includes ferrous ions. In one embodiment, the ratio of ferrous to ferric ions is from 10⁸:1 to 10⁶:1. In another embodiment, the ratio of ferrous to ferric ions is from 10⁴:1 to 10⁶:1.

In another embodiment, the flour used to make the bread product is not modified with a comestibly acceptable reagent, and instead a comestibly acceptable reagent is added to the flour as an ingredient in the dough mixture prior to baking The amount of comestibly acceptable reagent is still as set forth above. The flour, in its non-modified form, may include ferric ions, as free ions or bound ions, at least 1 mg/ 100 mg of flour. In one embodiment, the amount of ferric ions, as free ions or bound ions, is between about 4 mg/100 g flour and about 6 mg/100 g flour before treating with the comestibly acceptable reagent.

The pH of the dough or batter is in one case between 6 to about 7, and in one case is in a range having a lower end of about 6 or 6.1 or 6.2 or 6.3 or 6.4 or 6.5 or 6.6 or 6.7 or 6.8 and an upper end of about 6.9 or 6.8 or 6.7 or 6.6 or 6.5 or 6.4 or 6.3 or 6.2 or 6.1. It should be understood that the ranges of pH can have any one of the listed lower ends in combination with any one of the listed upper ends, so long as the lower end is lower than the upper end. Likewise a bread product may have a pH in the same range.

In another embodiment the pH of the dough or batter is maintained by a buffer using as a buffer component a leavening agent such as sodium aluminum phosphate also known as sodium alum phosphate; and a weak base, e.g., sodium bicarbonate. In general the total amount of leavening agent and weak base may not exceed 3% by weight of a wetted composition ready for baking The amounts of leavening agent are from 1 to 2% weight/weight; and of the weak base from 1 to 2% weight/weight.

Once the comestibly acceptable reagent is added to the flour itself before mixing with other ingredients or mixed with the flour at the time of adding other ingredients, the flour can be mixed with the other ingredients to form a dough or batter as mentioned above. The dough or batter can include any of a variety ingredients, including, but not limited to, water, milk, fat, leavening agents, egg and salt, or other ingredients outlined above. The dough is then baked into a bread product. The bread product can then be packaged with an egg product (for example, a scrambled egg) and optionally a protein product, such as lunch meats, hamburger, sausage, bacon, tofu, etc. to form a sandwich.

Generally the amount of the comestibly acceptable reagent in the flour composition is from about 0.05% weight/weight (“w/w”) of the overall composition (i.e., of the dough or batter) to about 0.29% w/w. In an embodiment where the flour is whole wheat flour the amount of the comestibly acceptable reagent in the flour is from about 0.26% to about 0.29% weight/weight (w/w); or from about 0.265% to about 0.285% w/w; or from about 0.27% to about 0.29% w/w; or from about 0.28% to about 0.29% w/w. In another embodiment where the flour is whole wheat flour, the amount of the comestibly acceptable reagent in the flour is about 0.285% w/w, 0.286% w/w, 0.287% w/w, 0.288% w/w, or 0.289% w/w. In another embodiment where the flour is whole wheat flour, the amount of the comestibly acceptable reagent in the flour is from about 0.05% w/w to about 0.14% w/w. In an embodiment where the flour is all purpose flour, the amount of the comestibly acceptable reagent is from about 0.1% to about 0.25% w/w.

In one case the sandwich is wrapped with a generally impervious, sealed package, such as a polymer wrap, and the wrapped sandwich is packaged in a box or other package with other wrapped sandwiches. The wrapped sandwich can be frozen before or after wrapping/packaging and remain in its frozen state until it is thawed and heated for consumption. The egg product and/or other protein product can be fully cooked, partially cooked, or uncooked at the time of packaging. In some cases, such as when the egg product forms the top or bottom layer of the contents of the sandwich, the egg product is in direct contact with the bread product. In other cases, the egg product may be an intermediate/middle layer of the sandwich and thus not in direct contact with the bread product. In this case, however, the egg product and bread product may be packaged within the same inner volume of a sandwich packaging, and therefore the sulfur products of the egg may be able to chemically react with the bread product.

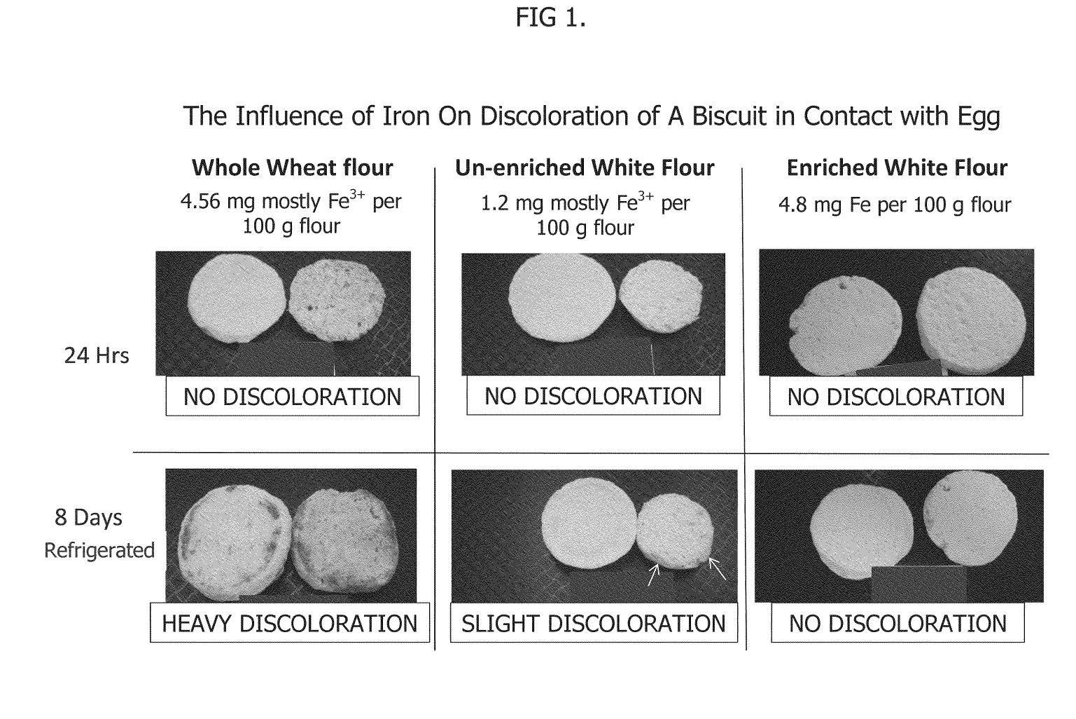

When bread products described herein are stored with an egg product at temperatures below room temperature, the bread product does not react with any sulfuric emissions from eggs for at least 14 days up to about 300 days depending upon the storage temperature. Accordingly, the discoloration seen in FIG. 1 after 8 days does not occur in this case. In one case, the bread product is substantially unreactive with any sulfur emissions, when packaged with an egg product and stored frozen, for up to about 300 days, or for up to about 280 days, or for up to about 270 days, or for up to about 225 days, or for up to about 200 days, or for up to about 100 days, or for up to about 60 days. In other embodiments the bread product is substantially unreactive with any sulfur emissions of an egg product, when packaged with the egg product and stored at acceptable refrigerated temperatures, for up to about 45 days; or up to about 35 days; or up to about 31 days; or up to about 30 days; or up to about 28 days; or up to about 27 days, or up to about 14 days.

When bread products described herein are in contact with an egg product and stored at room temperature no discoloration occurs within 12 hours and still no discoloration occurs within 18 hours.

In one case, in order to provide the time lengths of unreactivity outlined above, the combined bread and the egg product (i.e., the sandwich) are stored at reduced and/or freezing temperatures; in one case between 0° C. and about 5° C. In one case the lower end of the temperature range is about −20° C., or about −15° C., or about −10° C., or about −5° C. or about −2° C., and the upper end of the temperature range is about 5° C. or about 4° C., or about 3° C., or about 2° C.

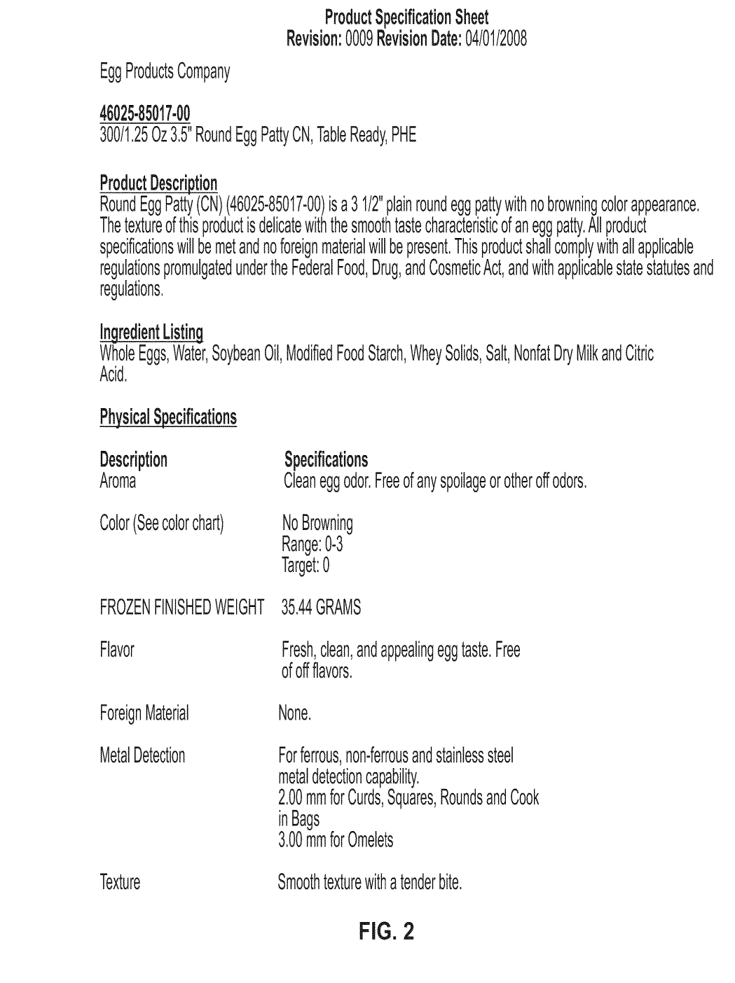

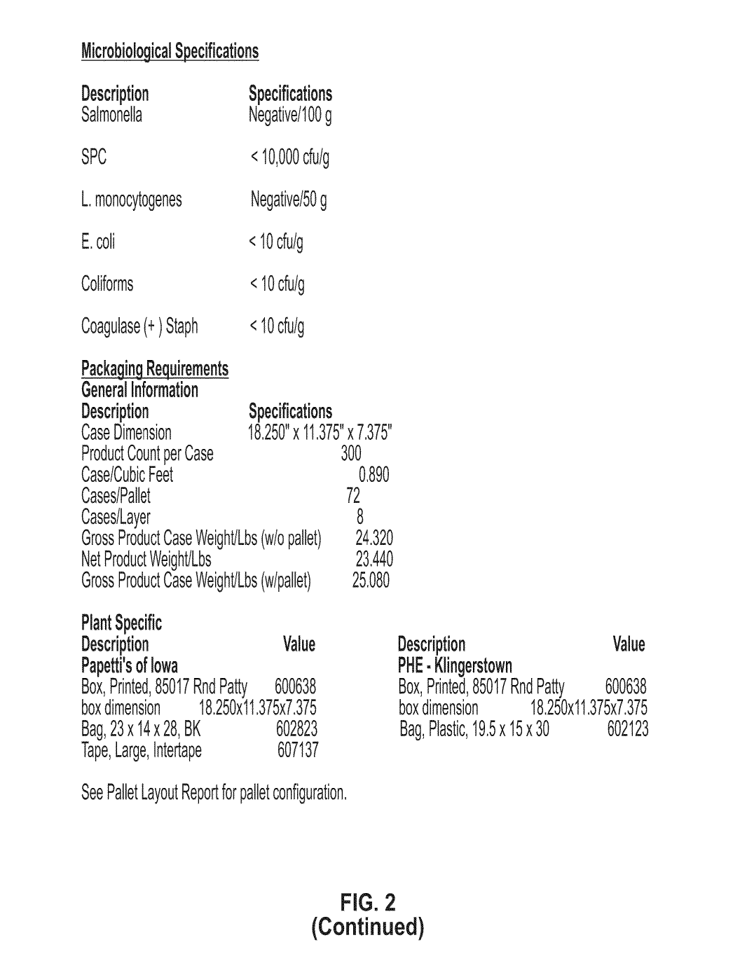

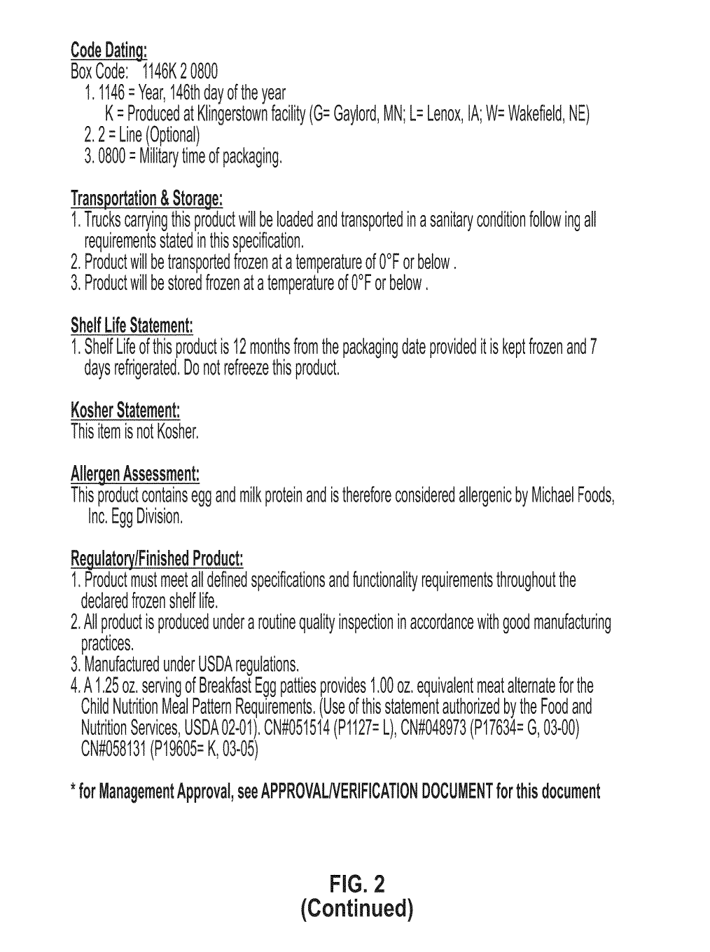

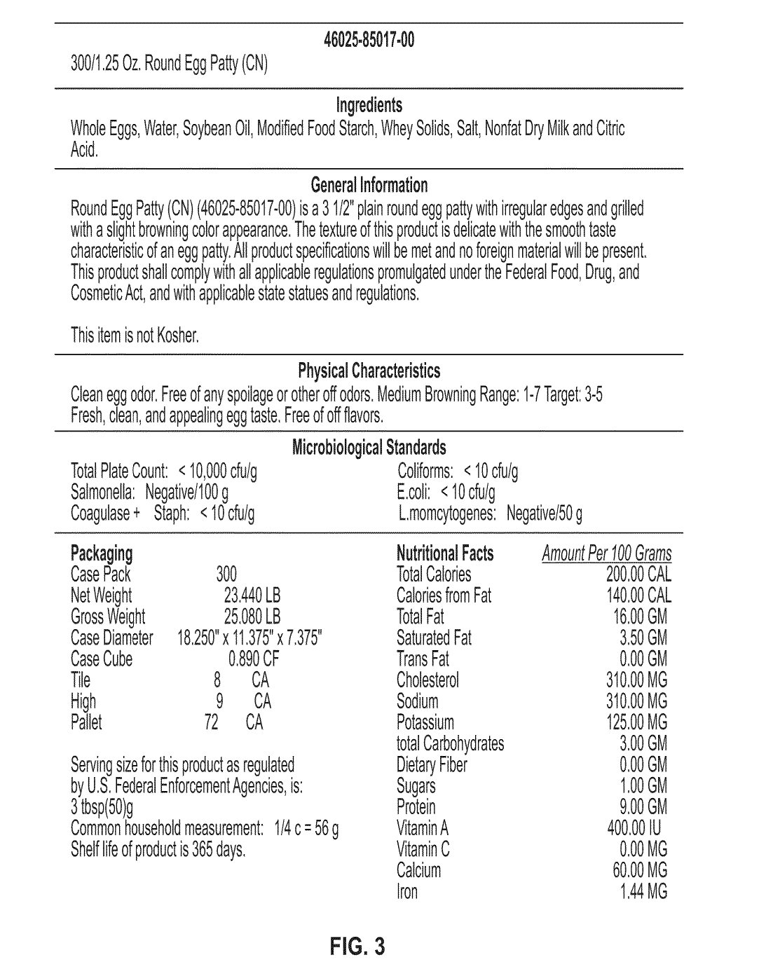

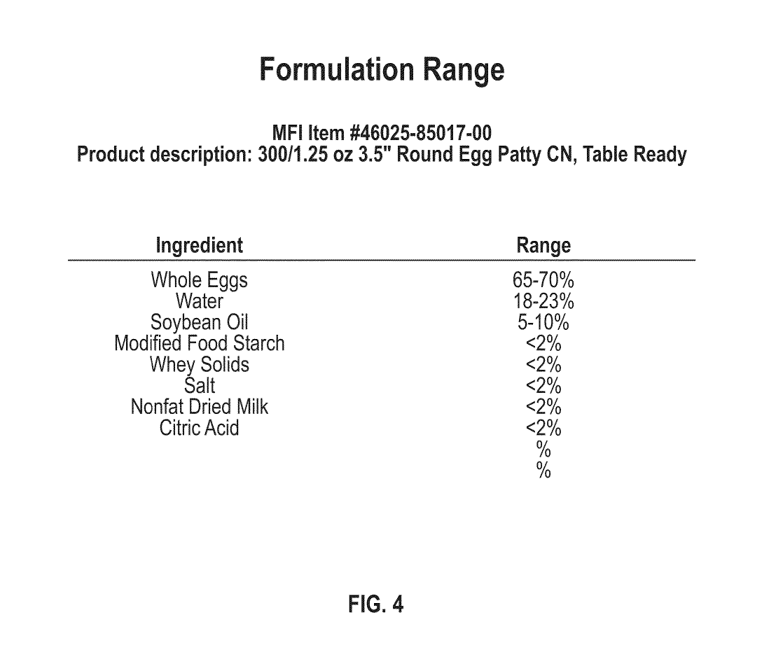

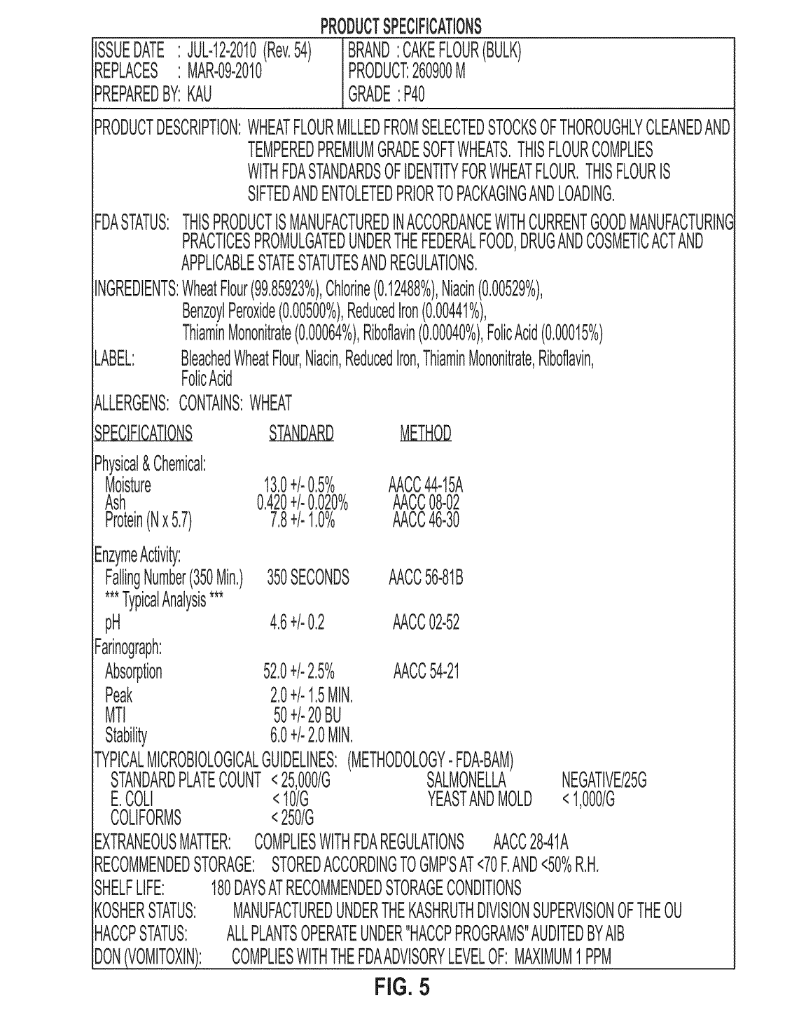

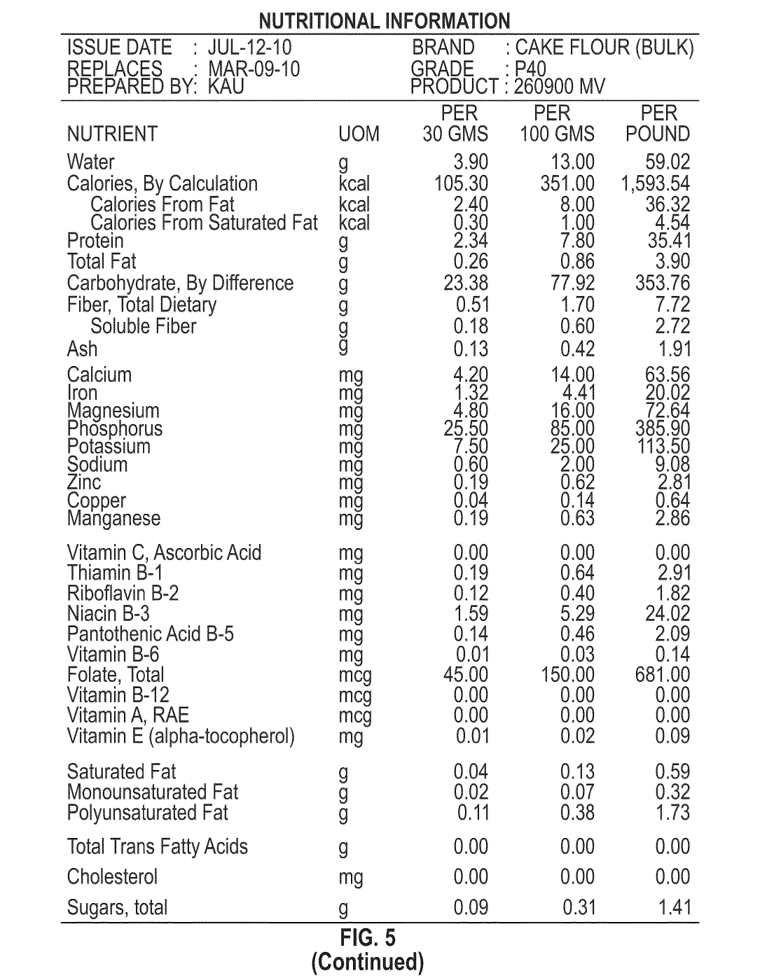

The weight/weight ratio of biscuit to egg is about 1:1 to about 1.5:1. One suitable egg product for an egg-biscuit sandwich is described in FIGS. 2-4.

### EXAMPLE 1

As a control for comparison purposes, biscuits were prepared according to the following recipe:
flour (49.4%)
Dairy Buttermilk blend (5.33%)
dextrose (1.76%)
granulated sugar (1.76%)
sodium alum phosphate (1.38%)
sodium bicarbonate (1.06%)
sodium chloride (0.38%)
calcium propionate (1.6%)
Methocel™ Cellulose Ether (1.6%)
Shortening (6.5%)
Water (29.23%)

A first set of biscuits was prepared using whole wheat flour containing about 4.56 mg iron per 100 g flour, generally believed to be mostly Fe(III). A second set of biscuits was prepared using unenriched white wheat flour containing about 1.2 mg of iron/100 g flour, generally believed to be mostly Fe(III). A third set of biscuits was prepared using enriched white wheat flour (All Purpose flour) containing about 4.8 mg of elemental iron/100 g flour. The biscuits were combined with scrambled egg and stored at 4° C. for 8 days. Discoloration was recorded as shown in FIG. 1.

### EXAMPLE 2

According to the disclosure herein, a biscuit batter is prepared by combining bulk hard wheat flour (23.5%), soft white whole wheat flour with 0.285% ascorbic acid (25.9%), Dairy Buttermilk blend (5.33%); dextrose (1.76%), granulated sugar (1.76%), sodium alum phosphate (1.38%), sodium bicarbonate (1.06%), sodium chloride (0.38%) calcium propionate (1.6%), Methocel™ Cellulose Ether (1.6%); Shortening (6.5%); and Water 29.23%). Note that the soft white whole wheat flour has ascorbic acid, one example of a comestibly acceptable reagent, added thereto. The resulting dough is kneaded and formed into biscuits and baked to provide biscuits of about 54 g average weight.

The biscuits are placed into contact with about 35 g scrambled egg product produced in a mold oven as an egg-biscuit sandwich, similar to those shown in FIG. 1. The egg-biscuit sandwiches are stored frozen for 270 days at less than 0° C. without visible discoloration, to the naked eye, of the bread products. The egg-biscuit sandwiches were also stored for up to 14 days at an acceptably refrigerated temperature, e.g., a temperature required as an industry standard for school sandwiches under refrigerated conditions, without visible discoloration of the bread products.

### EXAMPLE 3

Three biscuit batters are prepared by combining all-purpose flour (50.2805%), shortening (11.3%), a buttermilk blend (3.709%), Methocel™ Cellulose Ether (0.063%), Dextrose (1.214%), sodium chloride (Salt) (0.964%), sodium aluminium phosphate (1.05%), sodium bicarbonate (0.898%), calcium propionate (0.125%), water (30.395%) and ascorbic acid (all recipes measured to 100%). The all-purpose flours in the first, second, and third batters contain 0.1%, 0.15% and 0.2% of ascorbic acid, respectively. A control batter with no ascorbic acid is prepared. The pH of the control batter is about 6.6-6.9. The pH of the batters with ascorbic acid is from about 6.0 to 6.2.

The control experience discoloration at room temperature within 12 hours of contact with an egg product. The three batters containing ascorbic acid did not experience discoloration within 12 hours of contact with an egg product.

What is claimed is:

1. A flour composition comprising:
a flour having a ferric ion content, as either free ions or bound ions, of at least 1 mg/100 mg of flour; and
an amount of a comestibly acceptable reagent to reduce the ferric ions to ferrous ions;
wherein the comestibly acceptable reagent is in an amount to decrease the ferric ion content to 0.5 mg/100 mg or less.

2. The composition of claim 1, wherein the comestibly acceptable reagent is in an amount to decrease the ferric ion content to 0.1 mg/100 mg or less.

3. The composition of claim 1, further comprising one or more ingredients to form a dough or batter including a liquid, and, after reduction of the ferric ions, ferrous ions.

4. The composition of claim 3, wherein the ratio of ferrous to ferric ions is from 10⁴:1 to 10⁶:1.

5. The composition of claim 3, wherein the dough or batter has a pH between about 6.0 and about 6.7.

6. The composition of claim 3, wherein the comestibly acceptable reagent comprises about 0.05% to about 0.29% of the dough or batter.

7. The composition of claim 1, wherein the comestibly acceptable reagent includes one or more of ascorbic acid, a salt made from ascorbic acid, an ascorbic acid derivative, citric acid, a salt made from citric acid, and a citric acid derivative.

8. A bread product made the flour composition of claim 1.

9. A flour composition comprising:
a whole wheat flour or an all-purpose flour;
wherein the flour composition is substantially free of ferric ions.

10. The composition of claim 9, wherein the amount of ferric ions is less than 0.0005% weight/weight of the flour composition.

11. The composition of claim 9, wherein the ratio of ferrous to ferric ions is from 10⁴:1 to 10⁶:1.

12. The composition of claim 9, having a pH between about 6.0 and about 6.7.

13. The composition of claim 9, wherein the flour composition a cooked or baked bread product.

14. The composition of claim 13, wherein the bread product is in contact with or packaged with an egg product, and the bread product is unreactive with a sulfur product emitted from the egg product for a period of at least fourteen days when refrigerated at an acceptable refrigeration temperature during said period, as evidenced by a lack of discoloration of the bread product.

15. The composition of claim 13, wherein the bread product is in contact with or packaged with an egg product, and the bread product is unreactive with a sulfur product emitted from the egg product for a period of about 60 days to about 300 days when stored frozen during said period, as evidenced by a lack of discoloration of the bread product.

16. A method for preparing a flour composition, the method comprising:
providing a flour having a ferric ion content, as either free ions or bound ions, of at least 1 mg/100 mg of flour;
treating the flour with a comestibly acceptable reagent to reduce at least a portion of the ferric ions to ferrous ions.

17. The method of claim 16, further comprising adding ingredients to form the flour into a dough or batter; and baking or cooking the dough or batter into a bread product.

18. The method of claim 17, further comprising packaging the bread product with an egg product.

19. The product according to claim 16 wherein the amount of ferric ions is between about 4 mg/100 g flour and about 6 mg/100 g flour before treating with the comestibly acceptable reagent.

20. A food product comprising:
a bread product made of a flour treated with a comestibly acceptable reagent that decreased the amount of ferric ions therein, the bread product being substantially free of ferric ions; and
an egg product, wherein the egg product and the bread product are packaged together;
wherein the bread product is unreactive with a sulfur product emitted from the egg product for a first period of at least fourteen days when refrigerated at an acceptable refrigeration temperature during said first period or for a second period of about 60 days to about 300 days when stored frozen during said second period, as evidenced by a lack of discoloration of the bread product.
